(19) United States
(12) Patent Application Publication
(10) Pub. No.: US 2003/0190909 A1
(43) Pub. Date: Oct. 9, 2003

(54) Electronic mail receipt processing method and portable communication apparatus for practicing the same

(76) Inventor: Akimasa Matsushita, Saitama (JP)

Correspondence Address: DICKSTEIN SHAPIRO MORIN & OSHINSKY LLP, 41st Floor, 1177 Avenue of the Americas, New York, NY, 10036-2714, US

(21) Appl. No.: 10/408,304

(22) Filed: Apr. 8, 2003

(30) Foreign Application Priority Data
Apr. 8, 2002 (JP) 104698/2002

(51) Int. Cl. H04M 3/00

(52) U.S. Cl. 455/414.1; 455/418

(57) ABSTRACT

An electronic mail receipt processing method of the present invention includes the step of determining whether or not any one of character lines registered at a character line memory beforehand is contained in the title or the text of a received electronic mail, and the step of executing preselected processing if the character line is contained in the title or the text of the received mail.

### BACKGROUND OF THE INVENTION

1. Field of the Invention

The present invention relates to a method of executing, when an electronic mail is received, processing matching with the electronic mail, and a portable communication apparatus for practicing the same.

2. Description or the Background Art

It is a common practice with a portable personal telephone or similar portable communication apparatus capable of interchanging electronic mails to report the receipt of an electronic mail to the user of the telephone, as taught in, e.g., Japanese Patent Laid-Open Publication Nos. 2002-41414, 2001-352365, 2001-275159 and 10-283291. However, the conventional portable personal telephone does not allow the user to see the content of a received electronic mail, e.g., whether or not the mail is useful or important for the user. More specifically, the telephone simply alerts the user to the receipt of an electronic mail without regard to the content of the received mail, so that the user cannot see the degree of importance of the content of the mail.

Further, the conventional telephone simply reports the user of the receipt of an electronic mail having a preselected address and therefore stores even useless mails or stores them together with useful mails. This makes it difficult for the user to distinguish useful mails from useless mails.

The problems stated above are also true with any other portable communication system, e.g., a PHS (Personal Handyphone System).

### SUMMARY OF THE INVENTION

It is an object of the present invention to provide an electronic mail receipt processing method allowing a person to easily see if a received electronic mail is important for the user without opening it.

It is another object of the present invention to provide an electronic mail receipt processing method allowing a person to see whether or not a received electronic mail is of low degree of importance without opening it.

It is a further object of the present invention to provide a portable communication apparatus feasible for the electronic mail receipt processing method stated above.

An electronic mail receipt processing method of the present invention includes the step of determining whether or not any one of character lines registered at a character line memory beforehand is contained in the title or the text of a received electronic mail, and the step of executing preselected processing if the character line is contained in the title or the text of the received mail.

A portable communication apparatus for practicing the above method is also disclosed.

### BRIEF DESCRIPTION OF THE DRAWINGS

The above and other objects, features and advantages of the present invention will become more apparent from the following detailed description taken with the accompanying drawings in which:

FIG. 1 is a schematic block diagram showing a conventional portable personal telephone;

FIG. 2 is a flowchart demonstrating a specific operation of the conventional telephone of FIG. 1;

FIG. 3 is a schematic block diagram showing a portable personal telephone embodying the present invention;

FIG. 4 is a flowchart showing a specific operation of the illustrative embodiment;

FIG. 5 is a schematic block diagram showing an alternative embodiment of the present invention;

FIG. 6 is a flowchart showing a specific operation of the alternative embodiment;

FIG. 7 is a flowchart showing a procedure representative of another alternative embodiment of the present invention; and

FIGS. 8 and 9 are flowcharts showing a procedure representative of a further alternative embodiment of the present invention.

### DESCRIPTION OF THE PREFERRED EMBODIMENTS

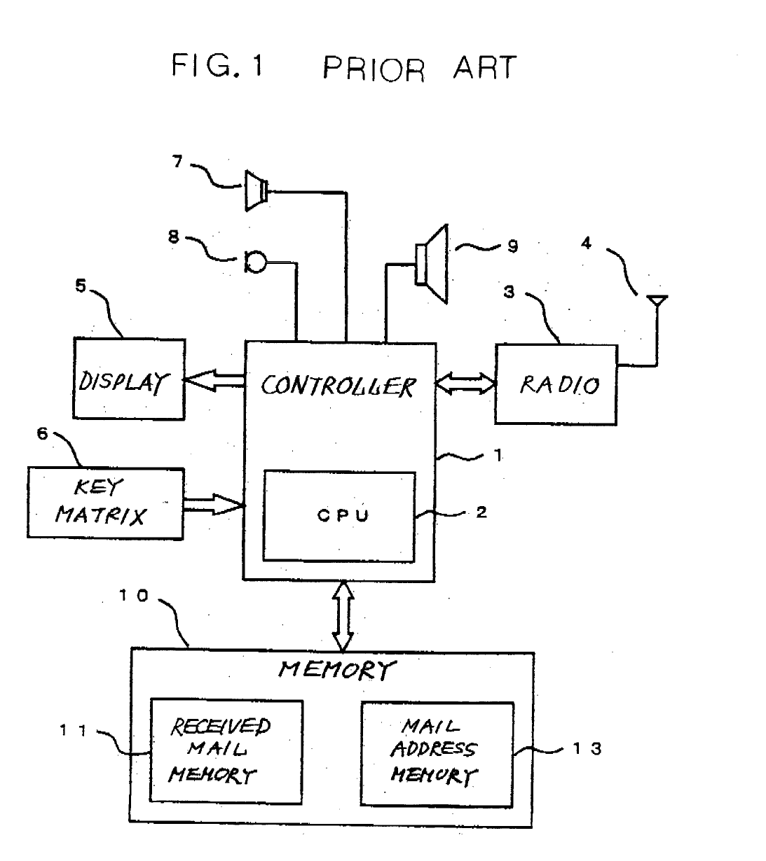

To better understand the present invention, brief reference will be made to a conventional portable personal telephone, shown in FIG. 1. As shown, the portable personal telephone includes a controller 1 including a CPU (Central Processing Unit) 2, a radio section a, an antenna 4, a display 5, a key matrix 6, a receiving section 7, a transmitting section 8, and a speaker 9. The telephone additionally includes a memory 10 including a received mail memory 11 and a mail address memory 13.

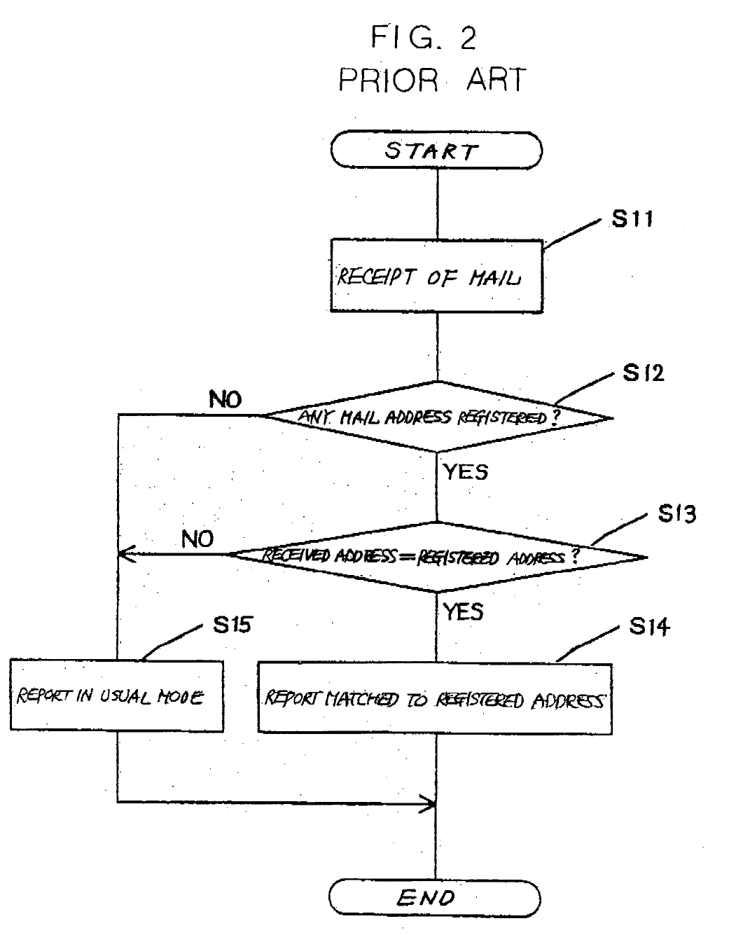

FIG. 2 demonstrates a specific operation of the portable personal telephone shown in FIG. 1. First, the user of the telephone operates the key matrix 6 to register the addresses of designated electronic mails (simply mails thereinafter) which should be reported in a particular manner each when received, at the mail address memory 13 via the CPU 2. In addition, the user registers a desired alert tone that should be output on the receipt of the designated mails.

As shown in FIG. 2, when a mail is received via the antenna 4 and radio Section 3 (step S11), the CPU 2 stores the received mail in the received mail memory 11 of the memory 10. The CPU 2 then determines whether or not at least one designated mail address is registered at the mail address memory 13 (step S12). If the answer of the step S12 is negative (NO), then the CPU 2 produces a usual alert tone via the speaker 9, alerting the user to the receipt of a usual mail (step S15).

If the answer of the step S12 is positive (YES), meaning that at least one designated mail address is registered at the mail address memory 13, then the CPU 2 determines whether or not the address of the mail stored in the received mail memory 11 is identical with the designated mail address registered at the mail address memory 13 (step S13). It the answer of the step S13 is NO, then the CPU 2 produces the usual alert tone via the speaker 9 while displaying the receipt of a mail on the display 5 in a usual mode (step S15).

If the answer of the step S13 is YES, then the CPU 2 executes report processing for informing the user of the receipt of a mail having the designated mail address (step 514). More specifically, the CPU 2 produces the desired alert tone showing the user that the received mail has the designated mail address via the speaker 9, and displays a message indicative of the receipt of such a particular mail on the display 5. This allows the user to see, without opening a received mail, if the received mail has the designated address.

However, the conventional electronic mail receipt processing method and portable personal telephone for executing it have some problems left unsolved, as discussed earlier.

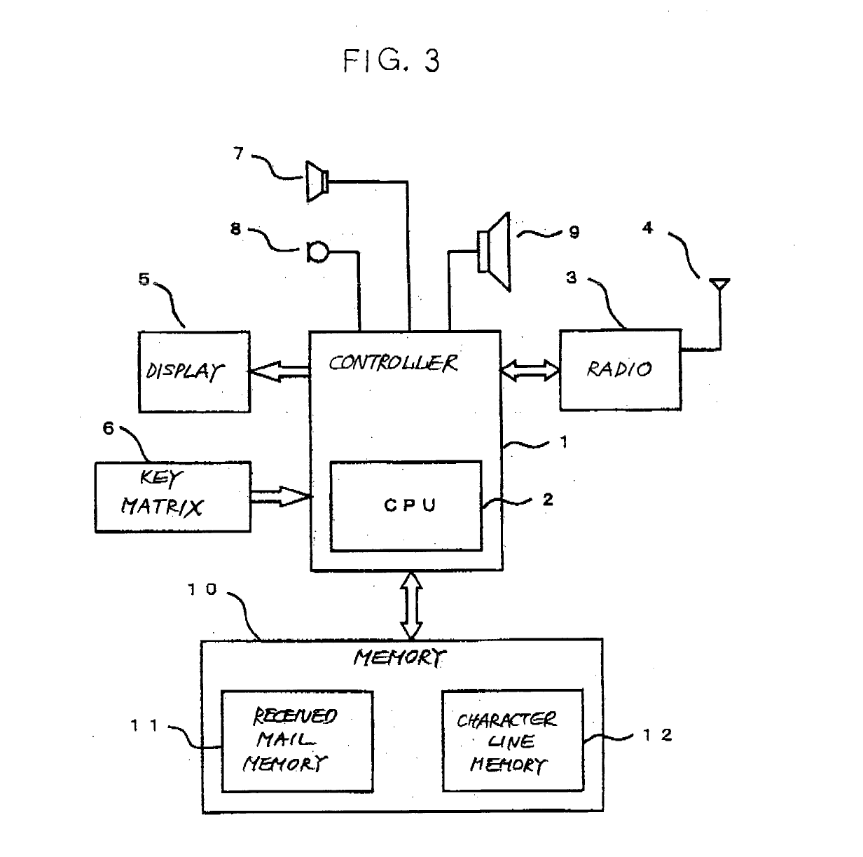

Referring to FIG. 3, a portable communication apparatus embodying the present invention is shown and implemented as a portable personal telephone by way of example. As shown, the portable personal telephone includes a controller or control means 1 including a CPU or processing means 2. The personal telephone further includes a radio section or transmitting/receiving means 3, an antenna 4, a display or reporting means 5, a key matrix or inputting means 6, a receiving section 7, a transmitting section 8, and a speaker or alerting means 9. The personal telephone additionally includes a memory 10 including a received mail memory or received mail storing means 11 and a character line memory 12.

The controller 1 controls the entire telephone. The CPU 2 included in the controller 1 executes processing to be described later in accordance with a program stored in the memory 10 beforehand. The radio section 3 transmits or receives, e.g., an electronic mail or voice via the antenna 4. The key matrix 6 is operated by the user of the telephone to input, e.g., telephone numbers or character lines for searching for desired one of received mails. Received mails are stored in the received mail memory 11 while the character lines mentioned above are stored in the character line memory 12.

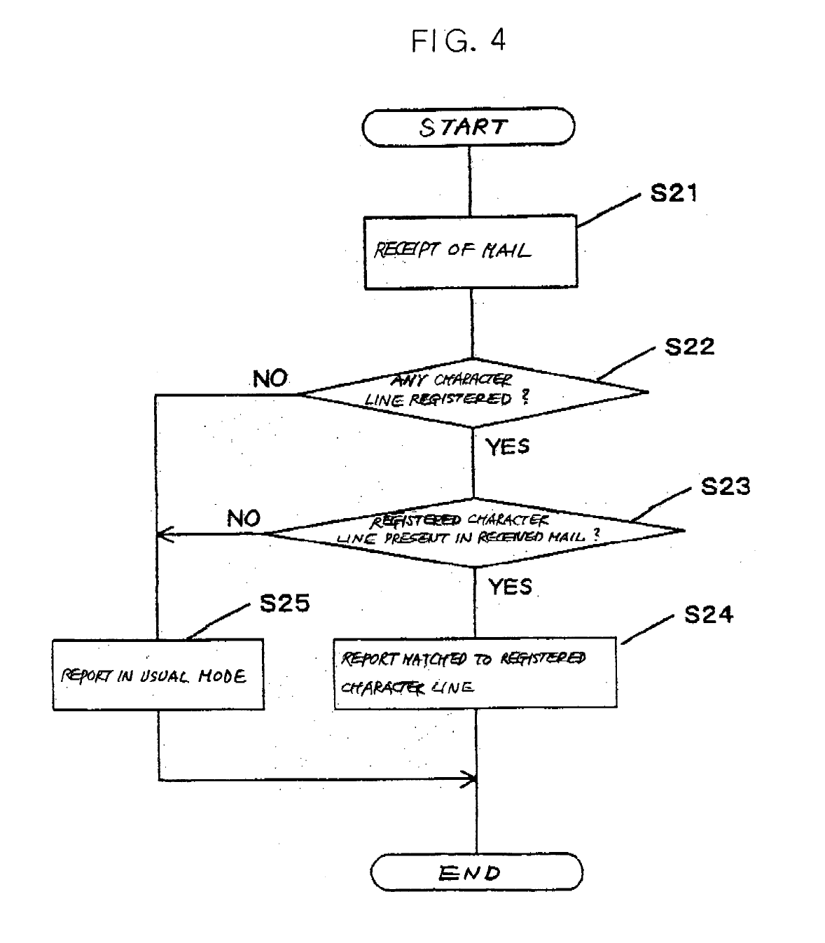

FIG. 4 shows a specific procedure to be executed by the telephone of FIG. 3, particularly the CPU 2 included therein. First, the user of the telephone operate the key matrix 6 to input a desired character line for search, e.g., “!advertisement!. The character line is written to the character line memory 12 under the control of the controller 1. The user additionally inputs the contents of report, i.e., the kind of an alert tone and a display mode on the key matrix 6, so that the receipt of a mail containing the registered character line can be reported in a manner different from the receipt of a usual mail.

A plurality of different character lines and different contents of report may be registered at the character line memory 12 in one-to-one correspondence by the operation described above. When the user does not register the contents of report, the user will be alerted in a single default mode even when a mail containing any one of the registered character lines is received.

As shown in FIG. 4, when a mail is received via the antenna 4 and radio section 4 (step S21), the CPU 2 stores the mail in the received mail memory 11 and then determines whether or not at least one character line is registered at the character line memory 12 (step S22). If the answer of the step S22 is NO, then the CPU 2 reports the receipt of a mail to the user via the speaker 9 and display 5 in a usual mode (step S25).

If the answer of the step S22 is YES, meaning that at least one character line is registered at the character line memory 12, then the CPU 2 determines whether or not the character line is contained in the mail stored in the received mail memory 11 (step S23). More specifically, the CPU 2 determines whether or not any one of the different character lines registered at the character line memory 12 is contained in the title or the text of the received mail. The step S23 constitutes character line determining means, If the answer of the step S23 is NO, then the CPU 2 reports the receipt of a mail to the user via the speaker 9 and display 5 in the usual mode (step S25),

If the answer of the step S23 is YES, then the CPU 2 reports the receipt of a mail in accordance with the contents corresponding to the character line registered at the character line memory 12 (step S24). More specifically, the CPU 2 produces an alert tone indicative of the receipt of a mail containing the registered character line in its title or text and displays a message indicative of the receipt of such a mail on the display 5. The user can therefore see the receipt of a mail containing the registered character line. For example, when the character line is “!advertisement!”, the user can see that the received mail contains the character line “!advertisement!” in its title or text. The steps S24 and S25 constitute reporting means.

As stated above, in the illustrative embodiment, only when a mail containing a character line registered beforehand as a keyword for search is received, the receipt of the mail is reported to the user in accordance with the contents of report also registered beforehand and different from contents assigned to the receipt of a usual mail. The above contents include an alert tone and a message indicative of the receipt of a mail This allows the user to easily see, without opening a received mail, if the content of the mail is useful or important for the user or not. The user is therefore surely prevented from failing to open an important received mail at adequate time.

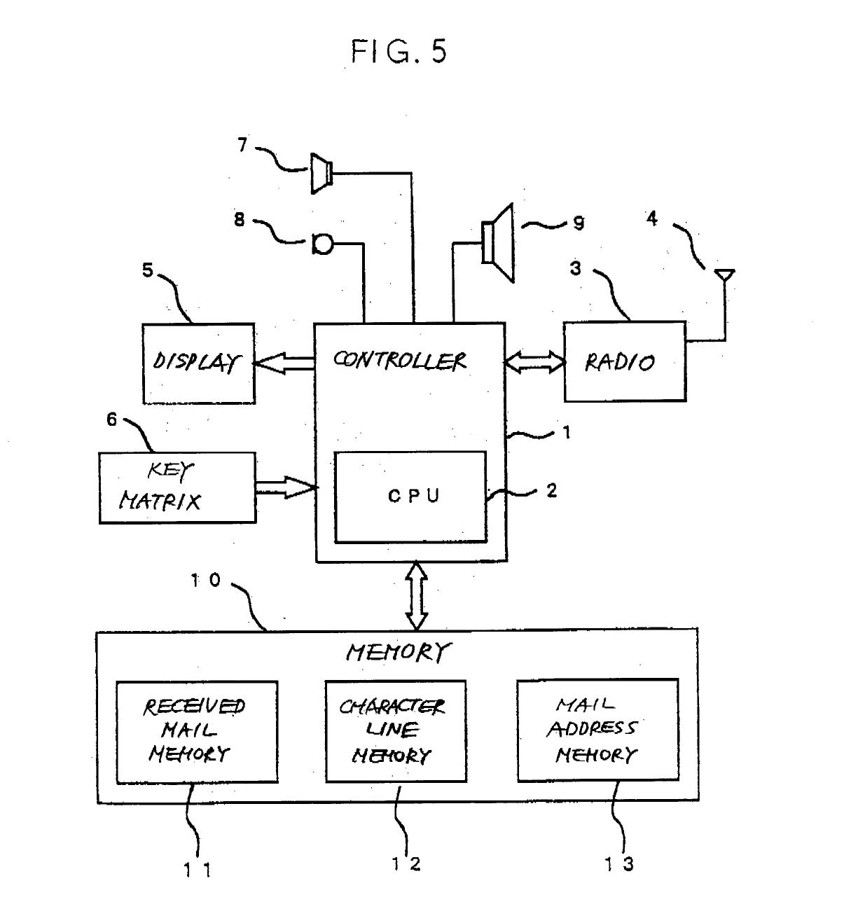

Reference will be made to FIG. 5 for describing an alternative embodiment of the present invention and also implemented as a portable personal telephone. As shown, this embodiment differs from the previous embodiment in that the memory 10 includes a mail address memory 13 in addition to the received mail memory 11 and character line memory 12. In FIG. 5, structural elements identical with those shown in FIG. 3 are designated by identical reference numerals and will not be described specifically in order to avoid redundancy. The mail address memory 13 is configured to store designated mail addresses, i.e., the addresses of mails to be reported in accordance with registered contents when received.

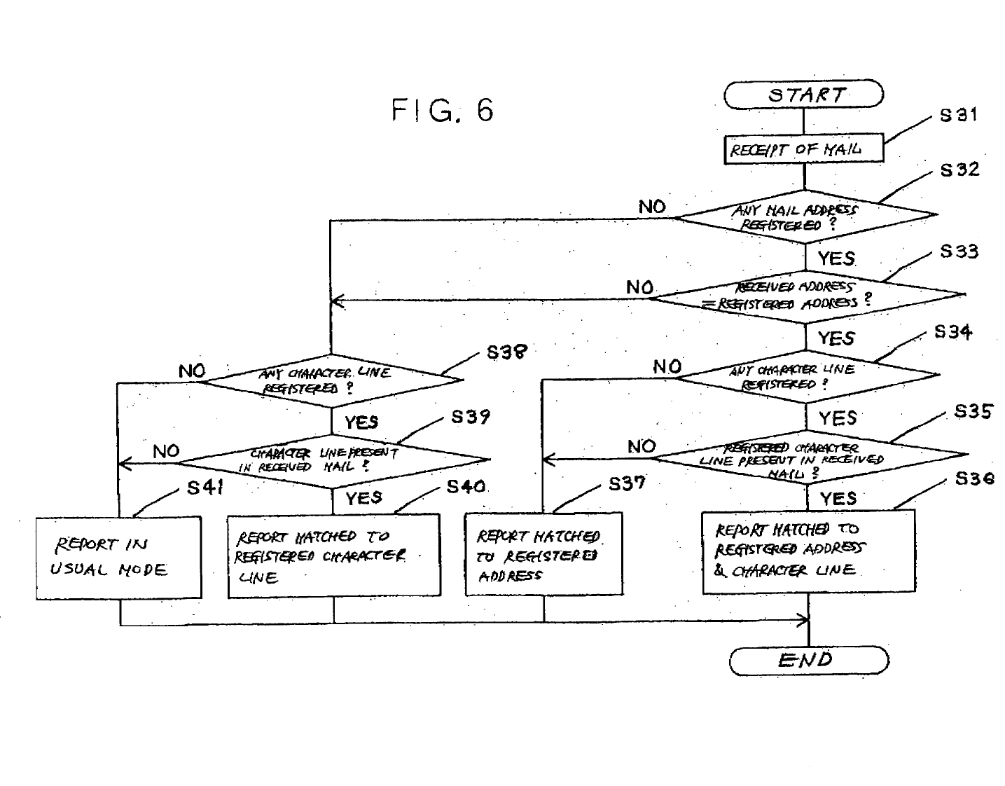

FIG. 6 demonstrates a specific procedure to be executed by the CPU 2 in the illustrative embodiment. First, the user of the telephone registers desired character lines and contents of report in one-to-one correspondence in exactly the same manner as in the previous embodiment. In the illustrative embodiment, the user additionally inputs designated mall addresses on the key matrix 6. The designated mail addresses are written to the mail address memory 13 under the control of the controller 1. Further, the user inputs contents of report, i.e., the kind of an alert tone and a display mode matched to the designated mail addresses, which are written to the mail address memory 13, on the key matrix 6, so that the receipt of a mail with any one of the designated mail addresses can be reported in a mode different from the mode assigned to the receipt of a usual mail. Again, when the user does not register the contents of report, the user will be alerted in a single default mode even when a mail with a designated mail address is received.

As shown in FIG. 6, when a mail is received via the antenna 4 and radio section 4 (step S21), the CPU 2 stores the mail in the received mail memory 11 and then determines whether or not at least one designated mail address is registered at the mail address memory 13 (step S32). If the answer of the step S32 is NO, then the CPU 2 determines whether or not at least one character line is registered at the character line memory 12 (step S38). If the answer of the step S38 is NO, then the CPU 2 reports the receipt of a mail to the user via the speaker 9 and display 5 in a usual mode (step S41).

If the answer of the step S38 is YES, meaning that at least one character line is registered at the character line memory 12, then the CPU 2 determines whether or not the character line is contained in the mail stored in the received mail memory 11 (step S39). More specifically, the CPU 2 determines whether or not any one of the different character lines registered at the character line memory 12 is contained in the title or the text or the received mail. If the answer of the step S39 is NO, then the CPU 2 reports the receipt of a mail to the user via the speaker 9 and display 5 in the usual mode (step S41).

If the answer of the step S39 is YES, then the CPU 2 reports the receipt of a mail in accordance with the contents corresponding to the character line registered at the character line memory 12 (step S40). More specifically, the CPU 2 produces an alert tone indicative of the receipt of a mail containing the registered character line in its title or text and displays a message indicative of the receipt of such a mail on the display 5. The user can therefore see the receipt of a mail containing the registered character line.

If the answer of the step S32 is YES, meaning that at least one designated mail address is registered at the mail address memory 13, then the CPU 2 determines whether or not the source mail address of the received mail is identical with the designated mail address (step S33). In this sense, the step S33 constitutes mail address determining means. If the answer of the step S33 is NO, then the CPU 2 executes the step S38 stated earlier. On the other hand, if the answer of the step S33 is YES, then the CPU 2 determines whether or not at least one character line is registered at the character line memory 12 (step S34)

If the answer of the step S34 is NO, then the CPU 2 reports the receipt of the mail in accordance with the contents assigned to the designated mail address (step S37). More specifically, the CPU 2 reports the receipt of a mail with the designated source mail address to the user via the speaker 9 and display 5.

If the answer of the step S34 is YES, then the CPU 2 determines whether or not any one of the character lines stored in the character line memory 12 is contained in the title or the text of the mail stored in the received mail memory 11 (step S35). If the answer of the step S35 is NO, then the CPU 2 executes the step S37 stated earlier. The steps S36, S37, S40 and S41 constitute reporting means.

If the answer of the step S35 is YES, meaning that any one of the character lines registered at the character line memory 12 is contained in the received mail, then the CPU 2 reports the receipt of the mail to the user in accordance with the contents matched to the character line (step S36).

If desired, for the above report, use may be made of both of the designated mail address and character line. In such a case, the CPU 2 outputs both of an alert tone indicative of the receipt of a mail with the designated source mail address and an alert tone indicative of a mail with the registered character line via the speaker 9 at the same time Further, the CPU 2 displays messages corresponding to such alert tones on the display 5. The user can therefore see the receipt of a mail having the designated mail address and containing the registered character line. The designated mail addresses and registered character lines may be used to distinguish, e.g., friends and clients from the others. This allows the user to easily see, without opening a received mail, whether or not the mail is of importance.

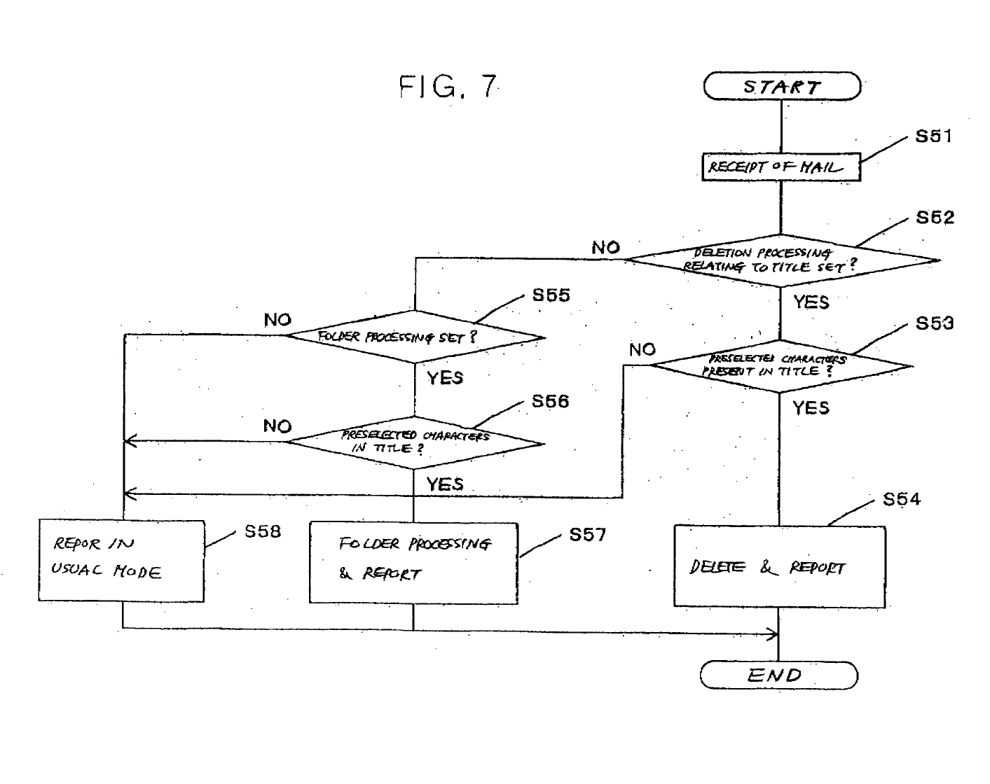

FIG. 7 shows another alternative embodiment of the present invention also practicable with the hardware of FIG. 3 except for the following. In the illustrative embodiment, the received mail memory 11 has a second folder for storing particular mails satisfying conditions preselected by the user and a first folder for storing usual mails other than the particular mails. The first folder plays the role of first received mail storing means for temporarily storing a received mail as well while the second folder plays the role of second received mail storing means. The operation of the illustrative embodiment will be described with reference to FIGS. 3 and 7.

First, the user of the telephone operates the key matrix 6 to input character lines to be used for searching for characters contained in the title of a mail (title character lines hereinafter). Also, the user sets processing relating to the deletion of mails (deletion processing hereinafter) in one-to-one correspondence to the above character lines, processing for storing mails in the second folder instead of the first folder (folder processing hereinafter), and contents of report, i.e., the kind of an alert tone and a display mode. Of course, either one of the deletion processing and folder processing may be input alone. The title character lines, deletion processing and folder processing are written to the character line memory 12 while being matched one-to-one to each other.

As shown in FIG. 7, when a mail is received via the antenna 4 and radio section 3 (step S51), the CPU 2 writes the received mail in the first folder included in the received mail memory 11. The CPU 2 then determines whether or not deletion processing meant for a mail that contains any one of the registered title character lines, eg., “!advertisement!” is set in the character line memory 12 (step S52). In this sense, the step S52 constitutes deletion determining means.

If the answer of the step S52 is NO, then the CPU 2 determines whether or not folder processing relating to the second folder is set in the character line memory 12 (step S55). The step S55 constitutes folder determining means. If the answer of the step S55 is NO, then the CPU 2 reports the receipt of a mail to the user in the usual mode via the speaker 9 and display 5 (step S58). In this case, the received mail is held in the first folder as it is.

It the answer of the step S55 is YES, then the CPU 2 determines whether or not any one of the registered title character lines is contained in the title of the mail stored in the first folder (step S56). This step S56 constitutes character line determining means. If the answer of the step S56 is NO, then the CPU 2 again executes the step S58. In this case, the received mail is stored in the first folder as it is.

If the answer of the step S56 is YES, then the CPU 2 reports the receipt of a mail to be stored in the second folder and containing any one of the registered character lines (step S57). In this case, the CPU 2 transfers the mail stored in the first folder to second folder. At the same time, the CPU 2 informs the user of the transfer of the above mail from the first folder to the second folder via the speaker 9 and display 5 although this information is not essential.

If the answer of the step S52 is YES, meaning that deletion processing is set in the character line memory 12, then the CPU 2 determines whether or not any one of the registered title character lines is contained in the 6 title of the received mail (step S53). This step S53 constitutes character line determining means. If the answer of the step S53 is NO, then the CPU 2 executes the step S58 In this case, too, the received mail is stored in the first folder as it is.

If the answer of the step S53 is YES, then the CPU 2 deletes the received mail stored in the first folder while informing the user of the deletion of the mail via the speaker 9 and display 5 (step S54) Stated another way, the CPU 2 does not store the received mail. The steps S54, S57 and S58 constitute reporting means.

As stated above, when a mail containing a registered character line in its title is received, the illustrative embodiment deletes the mail or stores it in a storage area different from a storage area assigned to usual mails. Generally, a mail containing the character line “!advertisement!” is a mail for advertisement and, in many cases, not so important for the user. The user can therefore easily determine whether or not such a mail is important without opening it, i.e., deal with a received mail on the basis of, e.g., the degree of importance.

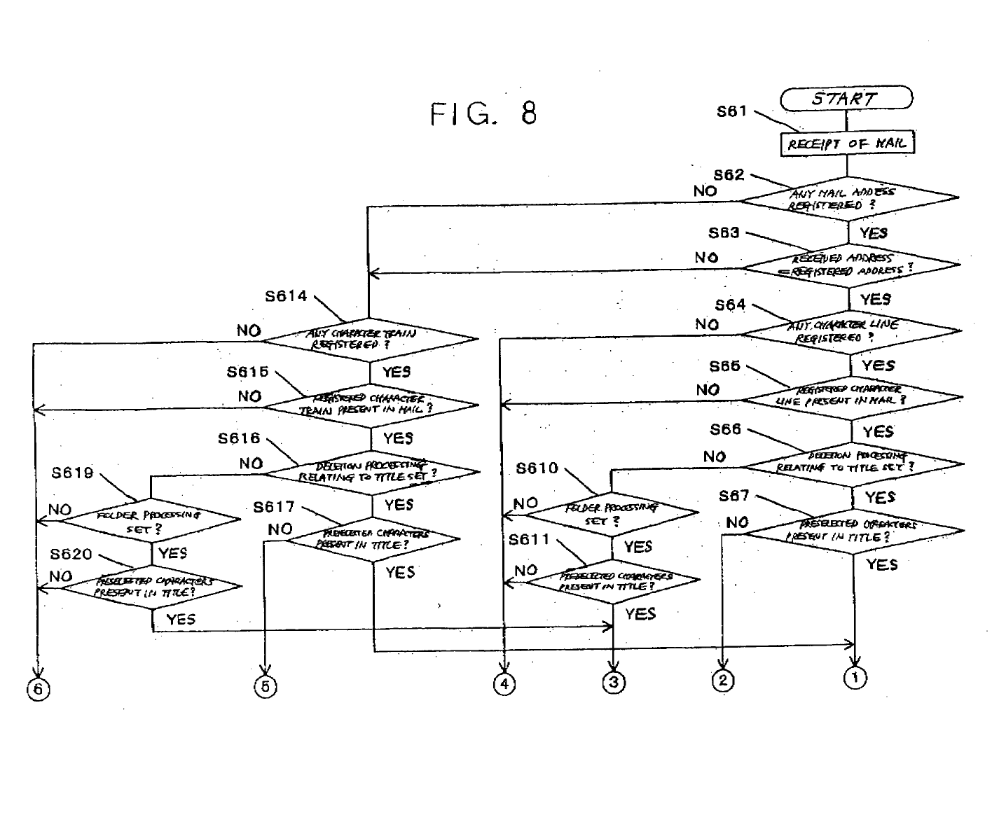

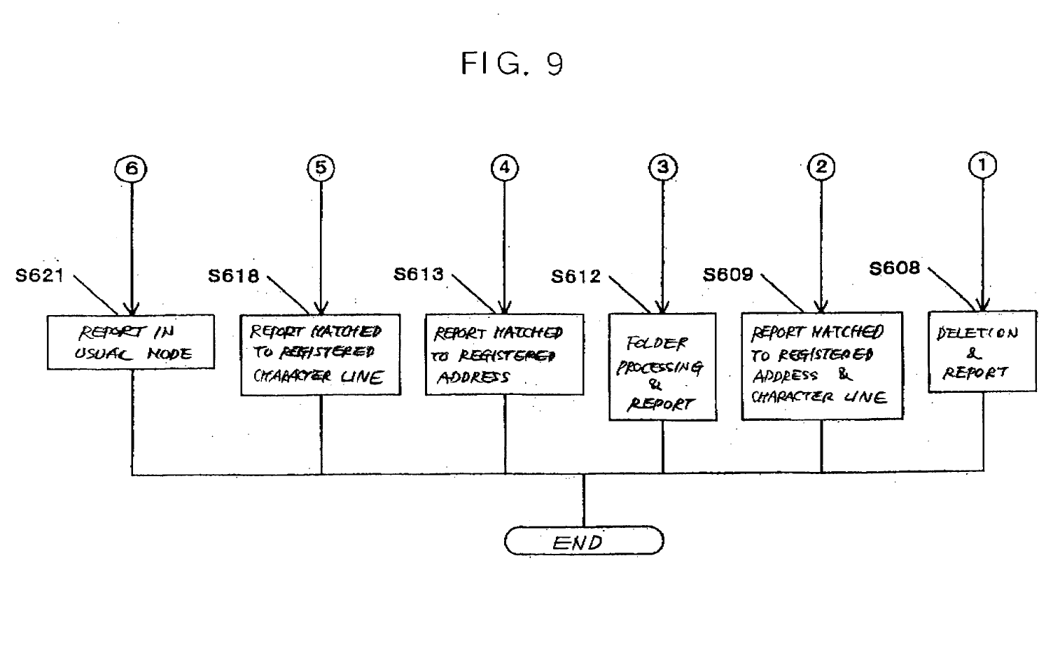

FIGS. 8 and 9 show a further alternative embodiment of the present invention also practicable with the hardware of FIG. 5 except for the following. In the illustrative embodiment, as in the embodiment described with reference to FIG. 7, the received mail memory 11 has a second folder for storing particular mails satisfying conditions preselected by the user and a first folder for storing usual mails other than the particular mails. Again, the first folder plays the role of first received mail storing means for temporarily storing a received mail as well while the second folder plays the role of second received mail storing means. The operation of the illustrative embodiment will be described with reference to FIGS. 3, 8 and 9.

First, the user of the telephone operates the key matrix 6 to input character lines, designated mail addresses, deletion processing, folder processing, and contents of report, i.e., the kind of an alert tone and a display mode. The character lines, deletion processing, folder processing and contents of report are written to the mail address memory 13 while being matched one-to-one to each other. In the illustrative embodiment, the character lines include search character lines for searching for character lines contained in the title and text of a mail and title character lines for searching for a character line contained in the title.

As shown in FIGS. 8 and 9, when a mail is received via the antenna 4 and radio section 3 (step S61), the CPU 2 writes the received mail in the first folder included in the received mail memory 11. The CPU 2 then determines whether or not at least one designated mail address is registered at the mail address memory 13 (step S62). If the answer of the step S62 is NO, then the CPU 2 determines whether or not at least one character line is registered at the character line memory 12 (step S614). If the answer of the step S614 is NO, then the CPU 2 informs the user of the receipt of a mail in the usual mode via the speaker 9 and display 5 (step S621). In this case, the received mail is stored in the first folder as it is.

If the answer of the step S614 is YES, then the CPU 2 determines whether or not any one of the search character lines stored in the character line memory 12 is contained in the title or the text of the mail stored in the first folder (step S615). This step S615 constitutes character line determining means. If the answer of the step S615 is NO, then the CPU 2 executes the step S621. If the answer of the step S615 is YES, then the CPU 2 determines whether or not the deletion of a mail is set in the character line memory 12 (step S616). In this sense, the step S616 constitutes deletion determining means.

If the answer of the step S616 is NO, then the CPU 2 determines whether or not folder processing is set (step S619). The step S619 constitutes folder determining means. If the answer of the step S619 is NO, then the CPU 2 executes the step S621 stated. In this case, the received mail is stored in the first folder as it is.

If the answer of the step S619 is YES, then the CPU 2 determines whether or not any one of the registered title character lines is contained in the title of the mail stored in the first folder (step S620). This step S620 constitutes character line determining means. If the answer of the step S620 Is NO, then the CPU 2 again executes the step S621. In this case, too, the received mail is stored in the first folder as it is.

If the answer of the step S620 is YES, then the CPU 2 executes the folder processing and report processing (step S612). More specifically, the CPU transfers the mail stored in the first folder to second folder while informing the user of the transfer of the above mail from the first folder to the second folder via the speaker 9 and display 5.

If the answer of the step S616 is YES, meaning that delete processing is set, then the CPU 2 determines whether or not any one of the registered title character lines is contained in the title of the received mail (step S617). If the answer of the step S617 is NO, then the CPU 2 executes the step S618. If the answer of the step S617 is YES, then the CPU 2 informs the user of the deletion of the mail and the deletion of the mail containing a registered character line, e.g., “!advertisement!” in its title (step S608) If the answer of the step S62 is YES, meaning that at least one designated mail address is registered at the mail address memory 13, then the CPU 2 determines whether or not the address of the received mail is identical with the designated mail address (step S636). This step S636 constitutes mail address determining means. If the answer of the step S636 is NO, then the CPU 2 executes the step 614 stated earlier.

If the answer of the step S63 is YES, meaning that the address of the received mail and designated mail address compare equal, then the CPU 2 determines whether or not at least one character line is registered at the character line memory 12 (step S64). If the answer of the step S64 is NO, then the CPU 2 reports the receipt of the mail with the designated address via the speaker 9 and display 5 (step S613).

If the answer of the step S64 is YES, meaning that at least one search character line is registered at the character line memory 12, then the CPU 2 determines whether or not any one of the search character lines stored in the memory 12 is contained in the title of the text of the received mail stored in the first folder (step S65) This step S65 constitutes character line determining means. If the answer of the step S65 is NO, then the CPU 2 executes the step S613 stated earlier. If the answer of the step S65 is YES, then the CPU 2 determines whether or not deletion processing meant for a mail containing any one of the title character lines registered at the character line memory 12 is set (step S66). This step S66 constitutes deletion determining means.

If the answer of the step S6 is NO, then the CPU 2 determines whether or not folder processing meant for a received mail is set (step S610). This step S610 constitutes folder determining means. If the answer of the step S610 is No, then the CPU 2 executes the step S613 stated earlier. If the answer of the step S610 is YES, then the CPU 2 determines whether or not any one of the title character lines is contained in the title of the received mail (step S611). This step S611 constitutes character line determining means.

If the answer of the step S611 is NO, then the CPU 2 executes the step S613. If the answer of the step S611 is YES, then the CPU 2 executes folder processing and report processing (step S612). More specifically, the CPU 2 transfers the received mail from the first folder to the second folder.

If the answer of the step S66 is YES, meaning that deletion processing is set, then the CPU 2 determines whether or not any one of the character lines is contained in the title of the received mail (step S67). This step S67 constitutes character line determining means. If the answer of the step, S67 is NO, then the CPU 2 outputs a report relating to the designated mail address and search character line (step S609). In this case, the received mail is stored in the first folder as it is.

If the answer of the step S67 is YES, then the CPU 2 informs the user of deletion processing executed and the deletion of the mail containing a registered title character line in its title (step S608). The steps S608, S609, S612, S613, S618 and S621 constitute reporting means.

As stated above, the illustrative embodiment allows the user to easily determine whether or not a received mail is of primary importance without opening it, i.e., deal with a received mail on the basis of, e.g., the degree of importance.

While the illustrative embodiments shown and described have concentrated on a portable personal telephone, the present invention is applicable to any other portable communication apparatus capable of receiving electronic mails, e.g., a PHS.

The folder processing and deletion described above may be executed when the title of a received mail contains registered characters, thereby narrowing down received mails to which such processing should be applied. For example, it is possible to exclude a received mail which is not an advertisement, but contains “!advertisement!” in its text by chance. To broaden the range of received mails to which the above processing should be applied, the processing may be executed with received mails of the kind containing registered characters in their titles or texts, if desired.

In summary, in accordance with the present invention, the user of a portable communication apparatus can easily see if a received mail is useful or important for the user or not without opening it.

Various modifications will become possible for those skilled in the art after receiving the teachings of the present disclosure without departing from the scope thereof.

What is claimed is:

1. An electronic mail receipt processing method comprising;
a determining step of determining whether or not a character line stored in character line storing means beforehand is contained in a title or a text of a received electronic mail; and
a processing step of executing preselected processing if the character line is contained in the title or the text of the received electronic mail.

2. The method as claimed in claim l, wherein contents of the preselected processing are stored in said character line storing means while being matched to the character line, and
the processing matched to the character line is executed when the character line is contained in the title or the text of the received electronic mail.

3. The method as claimed in claim 1, wherein the preselected processing comprises storing the received electronic mail in second received mail storing means different from first received mail storing means assigned to a n electronic mail not containing the character line in a title or a text thereof.

4. The method as claimed in claim 3, wherein contents of the preselected processing are stored in said character line storing means while being matched to the character line, and
the processing matched to the character line is executed when the character line is contained in the title or the text of the received electronic mail.

5. The method as claimed in claim 1, wherein the preselected processing comprises not storing the received electronic mail.

6. The method as claimed in claim 5, wherein contents of the preselected processing are stored in said character line storing means while being matched to the character line, and
the processing matched to the character line is executed when the character line is contained in the title or the text of the received electronic mail.

7. The method as claimed in claim 1, wherein the preselected processing comprises report processing corresponding to the character line.

8. The method as claimed in claim 7, wherein contents of the preselected processing are stored in said character line storing means while being matched to the character line, and
the processing matched to the character line is executed when the character line is contained in the title or the text of the received electronic mail.

9. The method as claimed in claim 7, wherein the preselected processing comprises storing the received electronic mail in second received mail storing means different from first received mail storing means assigned to a n electronic mail not containing the character line in a title or a text thereof.

10. The method as claimed in claim 8, wherein contents of the preselected processing are stored in said character line storing means while being matched to the character line, and
the processing matched to the character line is executed when the character line is contained in the title or the text of the received electronic mail.

11. The method as claimed in claim 7, wherein the preselected processing comprises not storing the received electronic mail.

12. The method as claimed in claim 11, wherein contents of the preselected processing are stored in said character line storing means while being matched to the character line, and
the processing matched to the character line is executed when the character line is contained in the title or the text of the received electronic mail.

13. An electronic mail receipt processing method comprising:
a determining step of determining whether or not a source mail address of a received electronic mail is identical with a registered mail address registered at mail address storing means beforehand; and
a processing step of executing, it the source mail address is identical with the registered mail address, preselected processing that does not store the received electronic mail, while reporting a user that said received electronic mail is not stored.

14. The method as claimed in claim 13, wherein contents of the preselected processing are stored in said mail address storing means while being matched to the registered mail address, and
the processing matched to the registered mail address is executed when the source mail address is identical with the registered mail address.

15. An electronic mail receipt processing method comprising:
a determining step of determining whether or not a source mail address of a received electronic mail is identical with a registered mail address registered at mail address storing means beforehand; and
a processing step of executing, if the source mail address is identical with the registered mail address, preselected processing for storing the received electronic mail in second mail storing means different from first mail storing means assigned to an electronic mail whose mail address differs from said registered mail address.

16. The method as claimed in claim 15, wherein contents of the preselected processing are stored in said mail address storing means while being matched to the registered mail address, and
the processing matched to the registered mail address is executed when the source mail address is identical with the registered mail address.

17. A portable communication apparatus comprising:
inputting means for allowing a user of said portable communication apparatus to input a character line;
character line storing means for storing the character line input on said inputting means;
character determining means for determining whether or not the character line stored is contained in a title or a text of a received electronic mail; and
processing means for executing preselected processing when said character determining means determines that the character line is contained in the title or the text of the received electronic mail.

18. The apparatus as claimed in claim 17, wherein said inputting means allows the user to input contents of processing while said character line storing means stores said contents of processing while matching said contents to the character line, and
the processing matched to the character line is executed when said character line determining means determines that the character line is contained in the title or the text of the received electronic mail.

19. The apparatus as claimed in claim 17, wherein the preselected processing comprises storing the received electronic mail in second received mail storing means different from first received mail storing means assigned to an electronic mail not containing the character line in a title or a text thereof.

20. The apparatus as claimed in claim 19, wherein said inputting means allows the user to input contents of processing while said character line storing means stores said contents of processing while matching said contents to the character line, and
the processing matched to the character line is executed when said character line determining means determines that the character line is contained in the title or the text of the received electronic mail.

21. The apparatus as claimed in claim 17, wherein the preselected processing comprising not storing the received electronic mail.

22. The apparatus as claimed in claim 21, wherein said inputting means allows the user to input contents of processing while said character line storing means stores said contents of processing while matching said contents to the character line, and
the processing matched to the character line is executed when said character line determining means determines that the character line is contained in the title or the text of the received electronic mail.

23. The apparatus as claimed in claim 17, wherein the preselected processing comprises report processing corresponding to the character line.

24. The apparatus as claimed in claim 23, wherein said inputting means allows the user to input contents of processing while said character line storing means stores said contents of processing while matching said contents to the character line, and.
the processing matched to the character line is executed when said character line determining means determines that the character line is contained in the title or the text of the received electronic mail.

25. The apparatus as claimed in claim 23, wherein the preselected processing comprises storing the received electronic mail in second received mail storing means different from first received mail storing means assigned to an electronic mail not containing the character line in a title or a text thereof.

26. The apparatus as claimed In claim 25, wherein said inputting means allows the user to input contents of processing while said character line storing means stores said contents of processing while matching said contents to the character line, and
the processing matched to the character line is executed when said character line determining means determines that the character line is contained in the title or the text of the received electronic mail.

27. The apparatus as claimed in claim 23, wherein the preselected processing comprising not storing the received electronic mail.

28. The apparatus as claimed in claim 27, wherein said inputting means allows the user to input contents of processing while said character line storing means stores said contents or processing while matching said contents to the character line, and
the processing matched to the character line is executed when said character line determining means determines that the character line is contained in the title or the text of the received electronic mail.

29. A portable communication apparatus comprising:
inputting means for allowing a user of said portable communication apparatus to input an electronic mail address;
mail address storing means for storing the electronic mail address input on said inputting means;
mail address determining means for determining whether or not the a source mail address or a received electronic mail is identical with the electronic mail address stored in said mail address storing means;
processing means for executing, when said mail address determining means determines that the source mail address is identical with the electronic mail address stored, processing that does not store the received electronic mail; and
reporting means for reporting the user that said processing means has not stored the received electronic mail.

30. The apparatus as claimed in claim 29, wherein said inputting means allows the user to input contents of processing while said mail address storing means stores said contents of processing while matching said contents to the mail address stored, and
the processing means executes the processing matched to the mail address stored when the source mail address is identical with said mail address stored.

31. A portable communication apparatus comprising:
inputting means for allowing a user of said portable communication apparatus to input an electronic mail address;
mail address storing means for storing the electronic mail address input on said inputting means;
mail address determining means for determining whether or not the a source mail address of a received electronic mail is identical with the electronic mail address stored in said mail address storing means; and
processing means for storing, when the source electronic mail address is identical with the electronic mail address stored, the received electronic mail in second received mail storing means different from first received mail storing means assigned to an electronic mail whose electronic mail address differs from said electronic mail address stored.

32. The apparatus as claimed in claim 31, wherein said inputting means allows the user to input contents of processing while said mail address storing means stores said contents of processing while matching said contents to the mail address stored, and
the processing means executes the processing matched to the mail address stored when the source mail address is identical with said mail address stored.
